(19) United States
(12) Patent Application Publication
(10) Pub. No.: US 2025/0193651 A1
(43) Pub. Date: Jun. 12, 2025

(54) SYSTEM FOR EVALUATING CROSS-NETWORK VOICE PERFORMANCE

(71) Applicant: T-Mobile USA, Inc., Bellevue, WA (US)

(72) Inventors: ROOPESH KUMAR POLAGANGA, Bothell, WA (US); SANJAY BABURAO WAJE, Plano, TX (US); PRANAV BHATIA, PARSIPPANY, NJ (US)

(21) Appl. No.: 18/535,196

(22) Filed: Dec. 11, 2023

(51) Int. Cl. H04W 8/02; H04M 3/22

(52) U.S. Cl. CPC H04W 8/02; H04M 3/2254

(57) ABSTRACT

A system to determine a network responsible for cross-network voice call drop events. In some cases, the system may determine the responsible party for each voice call drop event between users of different networks and provide data associated with the voice call drop events to a customer service system.

### BACKGROUND

Today the number of mobile network operators continues to increase. Many of these mobile network operators provide capabilities for cross-network voice calling services to connect their customers with customers of other operators. In some cases, the cross-network voice calls may experience issues and/or interruption of services. However, as each network operator only has insight into the performance of their network, determining a cause of the interruption and any corrective actions is often difficult.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of an example cross-network voice interruption detection system according to some implementations.

FIG. 2 is another example block diagram of an example cross-network voice interruption detection system according to some implementations.

FIG. 3 is a flow diagram illustrating an example process associated with detecting parties responsible for a voice call drop event according to some implementations.

FIG. 4 is another flow diagram illustrating an example process associated with detecting parties responsible for a voice call drop event according to some implementations.

FIG. 5 is a flow diagram illustrating an example process associated with notifying user to a party responsible for a voice call drop event according to some implementations.

FIG. 6 is an example system that may implement the techniques described herein according to some implementations.

### DETAILED DESCRIPTION

Discussed herein is a cross-network voice interruption detection system that may be associated with a particular mobile network operator to assist in determining causes and corrective actions with regards to voice call events (e.g., issues and/or interruptions of service) between a first user of the mobile network operator and a second user associated with another third-party mobile network operator. For example, during cross-network voice calls (e.g., calls between users associated with two different networks), each network operator may only have data associated with their own network. Accordingly, determining a cause of any voice call event that reduces the quality of the user experience is often difficult to determine.

The cross-network voice interruption detection system discussed herein may be associated with a first mobile network operator. The cross-network voice interruption detection system may be configured to detect a voice call event, such as an interruption in service, between a first user of the first mobile network operator and a second user of another third-party mobile network operator (e.g., a second mobile network operator different than the first mobile network operator). In one example, the first user or the second user may be engaged in a voice call event that results in one party being unable to hear the other for more than a predetermined period of time (such as 10 seconds, 20 seconds, 30 seconds, or the like). In this example, if neither party ends the voice call, the call may be terminated by the user equipment (UE) when the period of time elapses. In some cases, the cross-network voice interruption detection system may obtain or otherwise receive network quality metrics, such as average mean opinion score (MOS), average jitter, average latency, average packet loss rate, and the like, associated with performance of the voice call on the first mobile network of the first mobile network operator. In other words, the cross-network voice interruption detection system may obtain or otherwise receive network quality metrics with regards to the associated mobile network.

The cross-network voice interruption detection system may also obtain or otherwise receive one or more event cause codes (e.g., session initiation protocol (SIP) cause codes). For example, the event cause codes may indicate a reason or cause for the voice call termination by the UE. In this example, if the event cause code indicates a timeout by a UE, the cross-network voice interruption detection system may compare the network quality metrics to one or more predetermined thresholds to evaluate if the first mobile network is the cause of the voice call event (e.g., the interruption in service).

If the cross-network voice interruption detection system determines that the first mobile network is the cause of the voice call event, the cross-network voice interruption detection system may send a notification including the call quality metrics, location data of the first user and the second user (e.g., state, county, connected tower, eNB/gNB sector, or the like), the event cause code, call duration, and the type of voice call (e.g., NR/LTE) to a system for evaluation of the cause and determination of any action to be taken to improve the performance of the first mobile network to prevent further similar voice call issues and/or interruptions. Likewise, the cross-network voice interruption detection system may send a notification to a customer support system such that if the first user contacts the customer support of the first mobile network regarding one or more voice call events, such as the interruption in the current example, the customer support staff may inform the first user that the cause of the interruption is the second mobile network, thereby improving customer satisfaction and service while reducing unfounded customer frustration with the first mobile network provider.

If the cross-network voice interruption detection system determines that the second mobile network (e.g., the third-party network of the second user) is the cause of the voice call event, the cross-network voice interruption detection system may determine data associated with the second user, such as name, phone number, UE identifier, location data of the second user, identity of the second mobile network operator, and the like. The cross-network voice interruption detection system may then provide the data associated with the second user to a customer acquisition system to assist the first mobile network operator in contacting potential new customers. For example, if voice calls are often dropped within a defined geographical region or area, the customer acquisition system may be configured to increase new customer marketing efforts within the defined geographical region or area to capitalize on poor performance of networks offered by third-party network providers. In some cases, the defined geographical region or area may be selected based on an overlap of high performance metrics (e.g., greater than one or more voice call quality thresholds) for the first mobile network and high number of voice call events associated with a third party mobile network provider (e.g., greater than one or more voice call event or interruption thresholds).

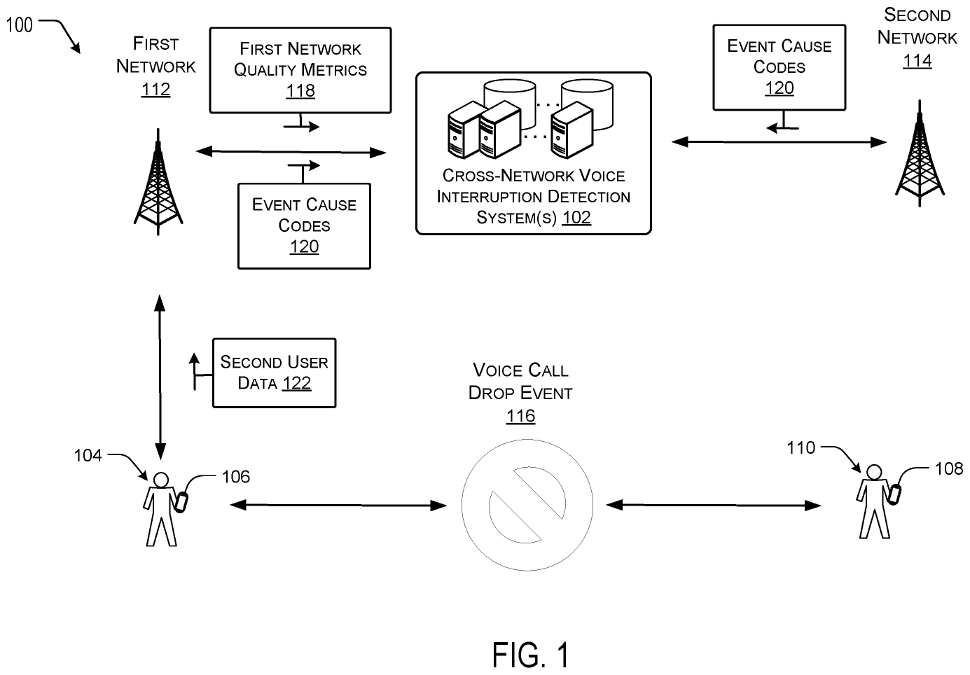

FIG. 1 is an example block diagram 100 of an example cross-network voice interruption detection system 102 according to some implementations. In the current example, a first user 104 may utilize a first UE 106 to engage in a voice call with a second UE 108 associated with a second user 110. In the current example, the first user 104 and the first UE 106 may be associated with a first network 112 (e.g., the network associated with the cross-network voice interruption detection system 102) and the second user 110 and the second UE 108 may be associated with a second network 114. In this manner, the first UE 106 is a customer or user of the first network 112 having a first operator and is engaged in a voice call with the second user 110 that is a customer or user of a different network or third-party network (e.g., the second network 114) having a different or second operator.

In the current example, the voice call may be dropped causing a voice call drop event, generally indicated by 116. In this case, the voice call drop event 116 may be caused by an issue with the first network 112 associated with the first user 104 and first UE 106 or the second network 114 associated with the second user 110 and the second UE 108. In this example, the cross-network voice interruption detection system 102 is configured to determine which of the first network 112 and the second network 114 are responsible for the voice call drop event 116. For example, the first UE 106 and/or components of the first network 112 (e.g., a session border controller (SBC), telephony application server (TAS), or the like) may send first network quality metrics 118 to the cross-network voice interruption detection system 102 in response to the voice call drop event 116.

The first network quality metrics 118 may include one or more call data records (CDR), reference signal received power (RSRP) metric, a reference signal received quality (RSRQ) metric, or the like. In some cases, the first network quality metrics 118 may also include one or more SIP cause codes indicating the cause of the voice call drop event 116. In other examples, such as is illustrated, the SIP cause codes 120 may also be received from the second network 114 in lieu of or in addition to the SIP cause codes from the first network 112.

The cross-network voice interruption detection system 102 may determine if the cause of the voice call drop event 116 is associated with the first network 112 based at least in part on the first network quality metrics 118. For instances, if the RSRP metric and/or the RSRQ metric are below or otherwise fail to meet or exceed one or more thresholds (e.g., quality level thresholds) and a SIP cause code 120 is received then the cause of the voice call drop event 116 may be associated with the first network 112. Otherwise, if the RSRP metric and/or the RSRQ metric are above or otherwise meets or exceeds one or more thresholds (e.g., quality level thresholds) and the SIP cause code 120 is received then the cause of the voice call drop event 116 is associated with the second network 114.

When the voice call drop event 116 is associated with the first network 112, the cross-network voice interruption detection system 102 may generate data, information, alerts, notification, or the like to provide to the operator of the first network to thereby identify and correct the issue. For example, the cross-network voice interruption detection system 102 may send an alert that causes the operator to upgrade one or more features of the first network 112, adjust one or more parameters or settings associated with the first network 112, install additional network equipment within a specific geographic region associated with the voice call drop event 116, or the like.

However, when the voice call drop event 116 is associated with the second network 114, the cross-network voice interruption detection system 102 may be configured to obtain data associated with the second user 110 and the second UE 108. For example, the first UE 106 may provide second user data 122 to the cross-network voice interruption detection system 102. The second user data 122 may include data associated with the second user's identity (e.g., phone number, name, and the like), the physical location of the second UE 108, and the like.

The cross-network voice interruption detection system 102 may then prepare an alert or notification to the operator of the first network 112 that the second user 110 may be experiencing issues with their operator and the second network 114 and that the first operator may utilize customer acquisition techniques and methods with a target of the second user 110. Likewise, the cross-network voice interruption detection system 102 may then prepare an alert or notification to the operator of the first network 112 that the second network 114 is experiencing service issues within a defined geographic area. For example, the cross-network voice interruption detection system 102 may aggerate data associated with voice call drop events associated with each third-party network (including the second network 114) to determine a defined geographic area in which users of the third-party network (e.g., the second network 114) are experiencing service issues. The cross-network voice interruption detection system 102 may then provide that defined geographic area to the customer acquisition system.

Likewise, when the voice call drop event 116 is associated with the second network 114, the cross-network voice interruption detection system 102 may identify the voice call drop events, such as voice call drop event 116, and provide them to a customer service system. In this manner, if the first user 104 contacts the customer service system (e.g., such as if the first user 104 regularly engages in voice calls with the second user 110, which are dropped due to the second network 114), the customer service system or a customer service operator may provide that information to the first user 104. Accordingly, with the information on the voice call drop events, the first user 104 is able to understand that the voice drop call events 116 that the first user 104 experiences are related to the second network 114 and, thereby, perceived quality of the first network 112 may be improved with respect to users, such as the first user 104 (e.g., the first user 104 no longer attributes the voice drop call events to the first network 112). In this manner, the cross-network voice interruption detection system 102 may improve customer retention, customer satisfaction, and perceived quality of the first network 112 compared with conventional network operations.

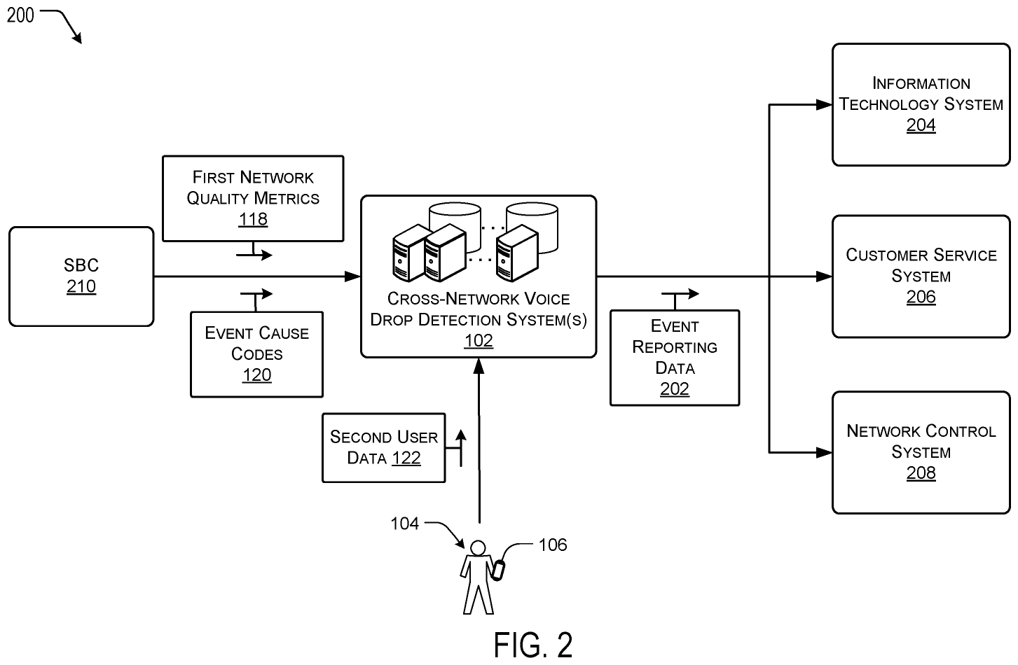

FIG. 2 is another example block diagram 200 of an example cross-network voice interruption detection system 102 according to some implementations. In the current example, a voice call drop event may have occurred between the first user 104 and a second user, such as second user 110 of FIG. 1. As discussed above, following the voice call drop event, the cross-network voice interruption detection system 102 of the network associated with the first user 104 may receive first network quality metrics 118, such as RSRP metrics and/or RSRQ metrics as well as event cause codes 120, such as SIP cause codes associated with the voice call drop event. As discussed above, the RSRP metrics and the RSRQ metrics may represent the status of the user's network during the call or for a period of time (e.g., a window of time) prior to the voice call drop event.

The cross-network voice interruption detection system 102 may then determine if the cause of the voice call drop event is associated with the user's network based at least in part on the first network quality metrics 118 and the event cause codes 120. For instances, if the RSRP metric and/or the RSRQ metric are below or otherwise fail to meet or exceed one or more thresholds (e.g., quality level thresholds) and a SIP cause code 120 is received then the cause of the voice call drop event may be associated with the user's network. Otherwise, if the RSRP metric and/or the RSRQ metric are above or otherwise meets or exceeds one or more thresholds (e.g., quality level thresholds) and the SIP cause code 120 is received then the cause of the voice call drop event is associated with a second network associated with the other party to the call.

When the voice call drop event is associated with the user's network, the cross-network voice interruption detection system 102 may generate event reporting data 202 to provide to other systems of the network. For example, the event reporting data 202 may be provided to an information technology system 204 to notify an operator to consider an upgrade to one or more features of the network, install additional network equipment within a specific geographic region associated with the voice call drop event, or the like. The event reporting data 202 may be provided to a network control system 206, such that the network control system 208 may determine an adjustment to one or more parameters or settings associated with the network.

However, when the voice call drop event is associated with the second network, the cross-network voice interruption detection system 102 may be configured to obtain data associated with the third-party user and the third-parties UE. For example, the first UE 106 may provide second user data 122 to the cross-network voice interruption detection system 102. The second user data 122 may include data associated with the second user's identity (e.g., phone number, name, and the like), the physical location of the third-party UE, a geographic region or area associated with the third-party UE, or the like. The cross-network voice interruption detection system 102 may then include the third-party data in the event reporting data 202 and the event reporting data 202 may also be provided to customer service system 206. The customer service system 206 may then utilize the event reporting data 202 to mitigate customer service inquires related to the voice call drop event (as the responsible party is the third-party network), provide active outreach to users, such as first user 104, with information related to third-party network issues, to provide outreach to third-party users for customer acquisition purposes, and the like.

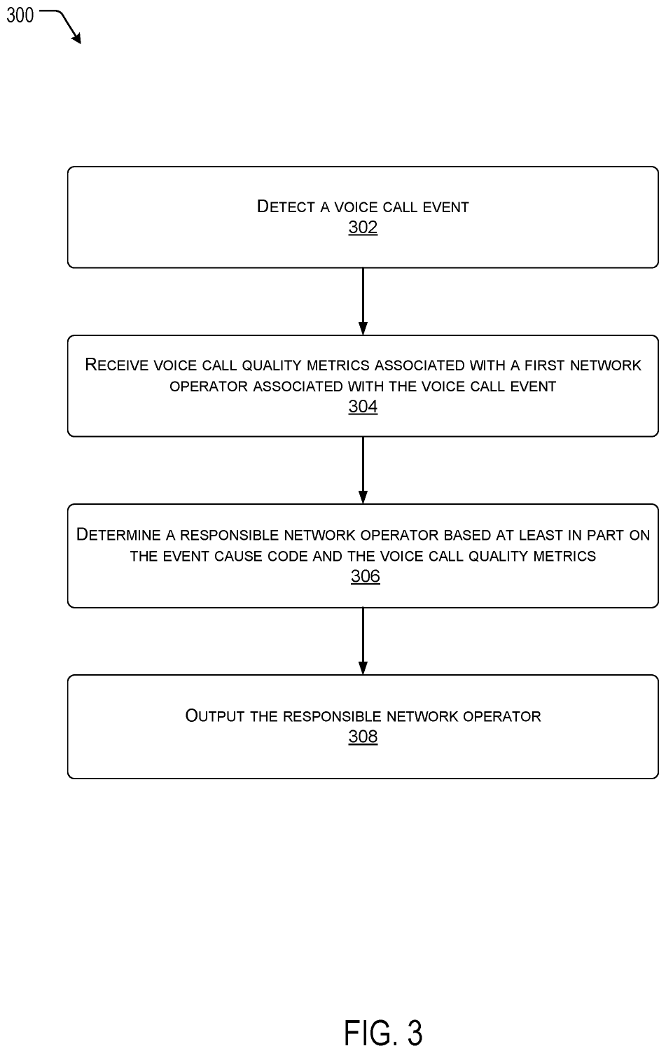

FIGS. 3-5 are flow diagrams illustrating example processes associated with the cross-network voice interruption detection system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a flow diagram illustrating an example process 300 associated with detecting parties responsible for a voice call drop event according to some implementations. As discussed above, voice call events, such as dropped calls or interruptions in service may occur between two users each associated with a different network operator (e.g., two different cellular or mobile networks or providers). With regards to maintaining a properly functioning network and for customer retention and acquisition, it is useful to determine the responsible operator for each of the voice call drops involved with a user's network.

At 302, a system associated with a first network may detect a voice call event (e.g., a dropped call, timeout, poor connectivity or signal, call failure, intermittent audio, fuzzy audio, or the like) between a user of the first network and a user of a second network associated with a different operator. For example, the system may receive a SIP cause code from an SBC (such as an I-SBC) positioned between components of the first and second networks. The SIP cause code may include a cause of the voice call event such as a drop call due to poor connectivity or signal.

At 304, the system may receive voice call quality metrics associated with a first network operator associated with the voice call event. For example, the system may receive RSRP metrics, RSRQ metrics, call record, call time/duration, user identifiers (e.g., phone numbers, names, and the like), location data (e.g., state, county, cell or tower identifier, GPS position, and the like), identity of the other network operator (e.g., the second network operator), voice type (e.g., NR, LTE, and the like), release cause, or the like. In other examples, the call quality metrics may include real-time protocol (RTP) average mean opinion score (MOS), RTP average jitter, RTP average latency, RTP average packet loss rate, and the like associated with the first network.

At 306, the system may determine a responsible network operator based at least in part on the event cause code and the voice call quality metrics. For instances, if the RSRP metric and/or the RSRQ metric of the first network are below or otherwise fail to meet or exceed one or more thresholds (e.g., quality level thresholds) and a SIP cause code is received then the cause of the voice call event may be associated with the first network of the user. Otherwise, if the RSRP metric and/or the RSRQ metric of the first network are above or otherwise meets or exceeds one or more thresholds (e.g., quality level thresholds) and the SIP cause code is received then the cause of the voice call event is associated with the second network.

At 308, the system may output the responsible network operator as the responsible party. For example, if the responsible party is the first network, the system may provide an output or report to an information technology system, a maintenance system, a network control system, or the like associated with the first network to assist in improving the overall performance of the first network. Alternatively, if the responsible party is the second network, the system may provide an output or report to a customer service system, a customer retention system, a customer acquisition system, or the like associated with the first network to assist in improving the overall customer service, network perceived quality, and customer acquisition metrics.

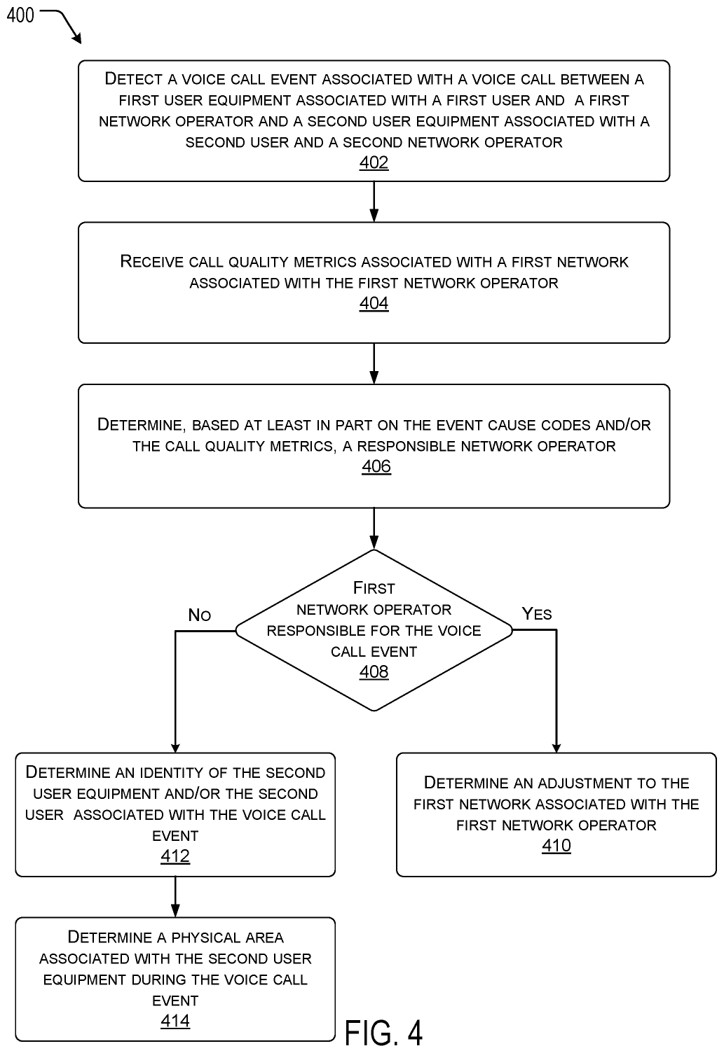

FIG. 4 is another flow diagram illustrating an example process 400 associated with detecting parties responsible for a voice call drop event according to some implementations. As discussed above, a system may be configured to determine a responsible party for a voice call event, such as a dropped call. The system may also be configured to provide reports and data to various other network systems based on the identity of the responsible party and/or aggregate voice call events over multiple users and period of time to determine issues with the associated network or with third-party networks.

At 402, the system may detect a voice call event associated with a voice call between a first UE associated with a first user and a first network operator and a second UE associated with a second user and a second network operator. For example, the system may receive a SIP cause code from an SBC (such as an I-SBC) positioned between components of the first and second networks. The SIP cause code may include a cause of the voice call event such as a drop call due to poor connectivity or signal.

At 404, the system may receive call quality metrics associated with a first network associated with the first network operator. For example, the system may receive RSRP metrics, RSRQ metrics, call record, call time/duration, user identifiers (e.g., phone numbers, names, and the like), location data (e.g., state, county, cell or tower identifier, GPS position, and the like), identity of the other network operator (e.g., the second network operator), voice type (e.g., NR, LTE, and the like), release cause, or the like. In other examples, the call quality metrics may include RTP average MOS, RTP average jitter, RTP average latency, RTP average packet loss rate, radio frequency strength, and the like associated with the first network.

At 406, the system may determine, based at least in part on the event cause codes and/or the call quality metrics, a responsible network operator. For instances, if the RSRP metric and/or the RSRQ metric of the first network are below or otherwise fail to meet or exceed one or more thresholds (e.g., quality level thresholds) and a SIP cause code is received then the cause of the voice call event may be associated with the first network of the user. Otherwise, if the RSRP metric and/or the RSRQ metric of the first network are above or otherwise meets or exceeds one or more thresholds (e.g., quality level thresholds) and the SIP cause code is received then the cause of the voice call event is associated with the second network.

At 408, the system may determine if the first network operator is responsible for the voice call event (e.g., the operator associated with the user). If the first network operator is responsible the process 400 may advance to 410. Otherwise, if the second network operator is responsible the process 400 may advance to 412.

At 410, the system may determine an adjustment to the first network associated with the first network operator. For example, the system may cause one or more parameters associated with a cell site or tower, load balancing, and the like. In other cases, the system may provide data associated with the drop call event to one or more other systems, such as an information technology system or a network control system. In general, the system may generate data, suggestions, recommendations, alerts or the like to assist with improved performance or identifying potential geographical areas or locations that may be experiencing performance concerns. In some cases, the system may aggregate voice call event data from multiple voice call events based on user identity, location (e.g., geographical area, cell site, tower, or the like), type of event, or the like to further assist with improving performance and reliability of the first network.

At 412, the system may determine an identity of the second UE and/or the second user associated with the voice call event. For example, the call quality metrics may include identity information (e.g., phone number) of the second user. In other cases, the identity information for the second user may be obtained from the SBC or the first UE (e.g., such as saved on the first UE via a caller ID or call history).

At 414, the system may determine a physical area associated with the second UE during the voice call event. As discussed above, the second device may be associated with a second user that is a customer of the second network operator. For example, the call quality metrics may include the cell or tower associated with the second UE. The system may then extract or determine a geographic area based on the cell or tower associated with the second UE during the call. In some cases, the system may utilize proximate dropped calls over a window of time to determine the geographic area where the second network has reoccurring performance issues. The geographic area may then be provided to a customer acquisition system to assist with determining competitors, areas, and/or regions to target.

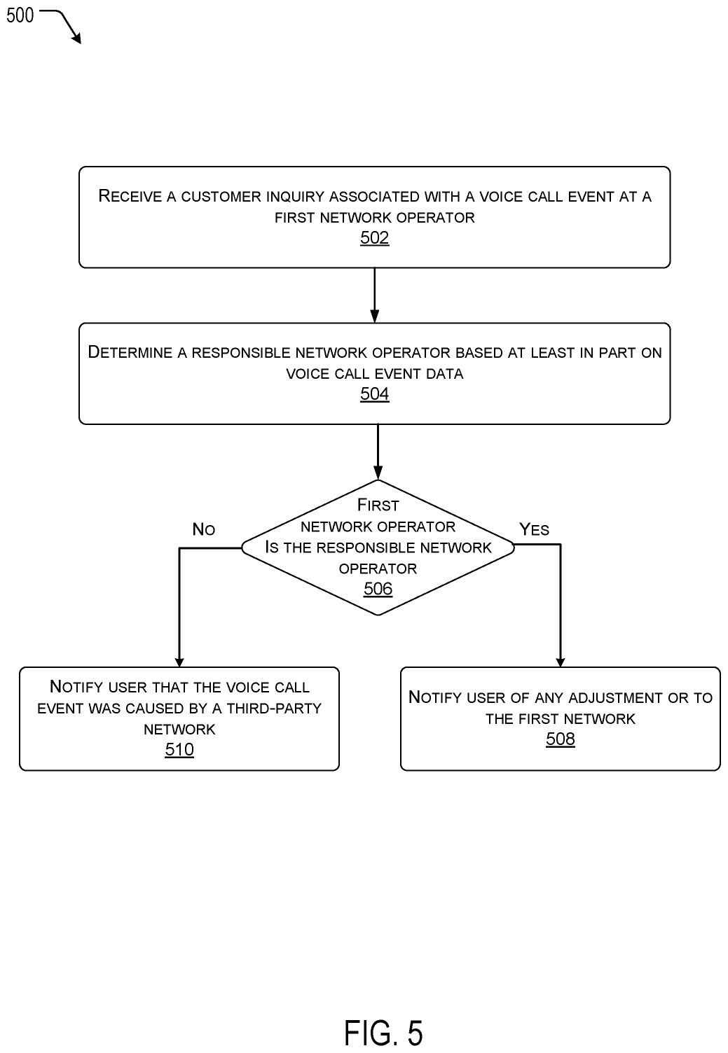

FIG. 5 is a flow diagram illustrating an example process 500 associated with notifying user to a party responsible for a voice call drop event according to some implementations. As discussed above, the cross-network voice interruption detection system is able to determine a responsible party for each voice call event (e.g., interruption, drop, or the like). The system may then provide a report or call event data to a customer service or customer retention system. A customer service representative and/or automated system may then provide the responsible party information to a user when a service complaint associated with the voice call event is received.

At 502, the system may receive a customer inquiry associated with a voice call event at a first network operator. For example, a user may call a customer service system or customer retention system in response to experiencing one or more voice call drop events.

At 504, the system may determine a responsible network operator based at least in part on voice call event data. For example, the voice call event data may include identification information (e.g., user's phone number, user's name, date, time, third-party user's name, third-party user's phone number, and the like) to allow the system to determine which of a plurality of voice call events are associated with the user currently inquiring.

At 506, if the system determines that the first network operator is the responsible network operator, the process 500 may proceed to 508. At 508, the system and/or a customer service representative may provide the user with notifications as to any adjustments to the first network to improve the user's performance. However, if the system determines that the first network operator is not the responsible network operator, the process 500 may proceed to 510. At 510, the system and/or a customer service representative may notify user that the voice call event was caused by a third-party network. In this manner, the first network may confirm for their customer and user that the performance issues that they have been experiencing in calls with the third-party network are caused by the third-party network, thereby improving customer perception of the first network.

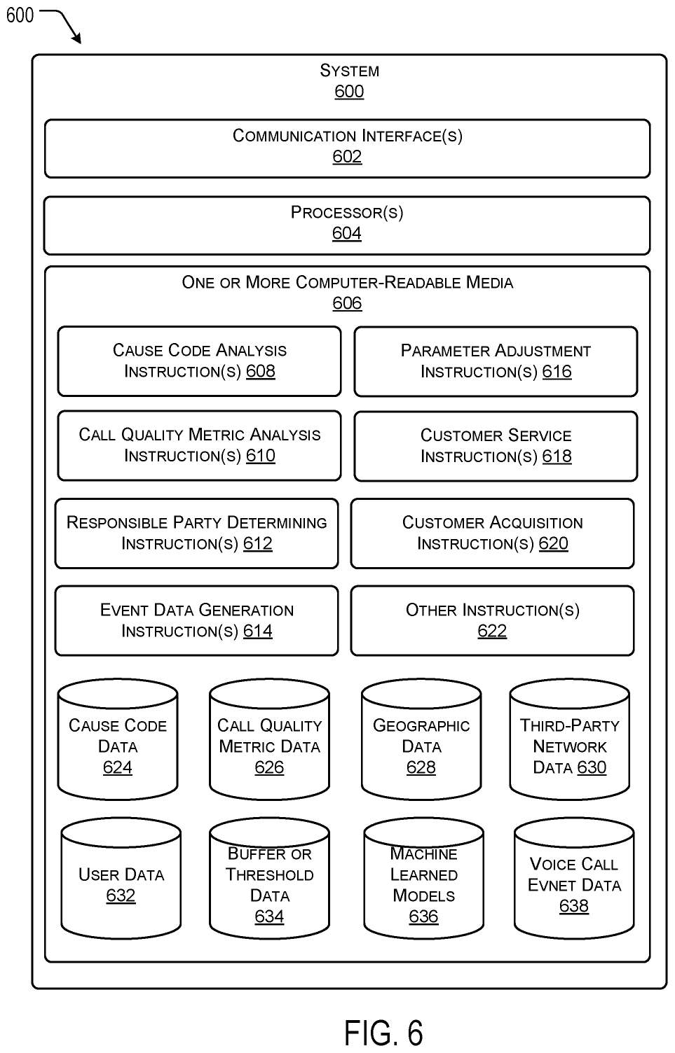

FIG. 6 is an example system 600, such as a cross-network voice interruption detection system, that may implement the techniques described herein according to some implementations. The system 600 may include one or more communication interface(s) 602 (also referred to as communication devices and/or modems), one or more processor(s) 604, and one or more computer readable media 606.

The one or more communication interfaces(s) 602 enable communication between the system 600 and one or more other local or remote computing device(s) or remote services, such as a user device (e.g., first UE 106) of FIG. 1. The communications interfaces(s) 602 may be Wi-Fi-based communication, short range wireless frequencies such as Bluetooth, cellular or mobile communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more processors 604 and the one or more computer-readable media 606. Each of the processors 604 may itself comprise one or more processors or processing cores. The computer-readable media 606 is illustrated as including memory/storage. The computer-readable media 606 may include volatile media (such as random access memory (RAM)) and/or nonvolatile media (such as read only memory (ROM), Flash memory, optical disks, magnetic disks, and so forth). The computer-readable media 606 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Several modules such as instructions, data stores, and so forth may be stored within the computer-readable media 606 and configured to execute on the processors 604. For example, as illustrated, the computer-readable media 606 stores cause code analysis instructions 608, call quality metric analysis instructions 610, responsible party determining instructions 612, event data generation instructions 614, parameter adjustment instructions 616, customer service instruction 618, customer acquisition instructions 620, as well as other instructions 622, such as an operating system. The computer-readable media 606 may also be configured to store data, such as cause code data 624, call quality metric data 626, geographic data 628, third-party network data 630, user data 632, threshold data 634, machine learned models 636, voice call event data 638, as well as other data.

The cause code analysis instructions 608, the call quality metric analysis instructions 610, and the responsible party determining instructions 612 may be configured to receive the cause codes for a voice call drop event, such as the SIP cause codes, and to determine a cause of the voice call drop event. The cause code analysis instructions 608, the call quality metric analysis instructions 610, and the responsible party determining instructions 612 may then be configured to receive the call quality metrics (e.g., RSRP metrics, RSRQ metrics, and the like) for the associated network and to determine based at least in part on the call quality metric data 626 associated with each voice call drop event and the threshold data 634 if the associated network or the third-party network is responsible or the voice call drop event.

The event data generation instructions 614 may be configured to generate data, such as geographic data 628 and user data 632 associated with the voice call drop events. For example, the event data generation instructions 614 may aggregate data from each voice call drop event to determine geographic areas, user devices, users, or the like that are experiencing lower than expected service or frequent interruptions of service that may be used by customer acquisition teams for targeted marking and/or outreach. In other cases, the event data generation instructions 614 may aggregate data from each voice call drop event to determine equipment, geographic areas, or the like that may be experiencing performance issues that may need to be corrected.

The parameter adjustment instructions 616 may be configured to utilize the voice call event data 638 to adjust one or more settings of the network to improve performance. In some cases, the parameter adjustment instructions 616 may utilize the one or more machine learned models 636 to generate the adjustments for the network, such as responsive to an input of the voice call event data 638.

The customer service instruction 618 may be configured to provide data associated with the third-party network in response to an inquiry into a voice call drop event that is the responsibility of the third-party network and/or feedback on any action taken by the network to improve performance when the third-party network is not responsible.

The customer acquisition instructions 620 may be configured to provide targeted outreach based at least in part on the user data 632, the geographic data 628, and/or the voice call event data 638. For example, the customer acquisition instructions 620 may include geographic areas, regions, or the like in a targeted outreach campaign based on the geographic data 628. The customer acquisition instructions 620 may also target specific individuals or phone numbers based on the user data 632 or the like.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

What is claimed is:

1. A method comprising:
detecting a voice call event associated with a first user of a first network and a second user of a second network;
receiving cause codes associated with the voice call event;
determining, based at least in part on the cause codes, that the voice call event is a voice call drop event;
receiving call quality metrics associated with the first network and the voice call event; and
determining, based at least in part on the call quality metrics, a responsible party for the voice call event.

2. The method of claim 1, wherein the responsible party is the second network and the method further comprises:
providing a notification to a customer service system including call event data.

3. The method of claim 1, wherein the responsible party is the second network and the method further comprises:
determining second user data associated with the second user; and
providing the second user data a customer acquisition system.

4. The method of claim 1, wherein the responsible party is the second network and the method further comprises:
determining one or more second voice call drop events associated with the second network; and
determining a geographic region associated with the second network based at least in part on the voice call drop event and the one or more second voice call drop events.

5. The method of claim 1, wherein the responsible party is the first network and the method further comprises:
determining, based at least in part on the call quality metrics, a parameter adjustment for the first network.

6. The method of claim 1, wherein the cause codes are session initiation protocol (SIP) cause codes.

7. The method of claim 1, wherein the call quality metrics includes at least one of a reference signal received power (RSRP) metric associated with the first network or a reference signal received quality (RSRQ) metric associated with the first network.

8. A system comprising:
one or more processors;
one or more communication interfaces; and
one or more computer-readable media storing instructions that, when executed by the one or more processors, cause the one or more processors to perform operations comprising:
receiving cause codes associated with a voice call event associated with a first user of a first network and a second user of a second network;
determining, based at least in part on the cause codes, that the voice call event is a voice call drop event;
receiving call quality metrics associated with the first network and the voice call event; and
determining, based at least in part on the call quality metrics, a responsible party for the voice call event.

9. The system of claim 8, wherein the operations further comprise determining a geographic area associated with the voice call event.

10. The system of claim 8, wherein the operations further comprise adding data associated with the second user to a customer acquisition system.

11. The system of claim 8, wherein determining the responsible party for the voice call event is based on a comparison of the call quality metrics to one or more thresholds.

12. The system of claim 8, wherein determining the responsible party for the voice call event is based on inputting the call quality metrics into one or more machine learned models.

13. The system of claim 8, wherein the cause codes are session initiation protocol (SIP) cause codes and the call quality metrics includes a reference signal received power (RSRP) metric associated with the first network and a reference signal received quality (RSRQ) metric associated with the first network.

14. One or more computer-readable media storing instructions that, when executed by one or more processors, cause the one or more processors to perform operations comprising:
receiving first cause codes and first call quality metrics associated with a first voice call event between a first user of a first network and a second user of a second network; and
determining, based at least in part on the first cause codes and the first call quality metrics, that the second network is a responsible party for the first voice call event.

15. One or more computer-readable media of claim 14, wherein the operations further comprise:
receiving second cause codes and second call quality metrics associated with a second voice call event between the first user of the first network and the second user of the second network; and
determining, based at least in part on the second cause codes and the second call quality metrics, that the second network is a responsible party for the second voice call event.

16. One or more computer-readable media of claim 15, wherein the operations further comprise:
In response to determining that the second network is the responsible party for the first voice call event and the second voice call event, determining a geographic area associated with the first voice call event and the second voice call event; and
sending the geographic area to a customer acquisition system.

17. One or more computer-readable media of claim 15, wherein the operations further comprise:
in response to determining that the second network is the responsible party for the first voice call event and the second voice call event, determining a geographic area associated with the first voice call event and the second voice call event; and
sending user data associated with the second user to a customer acquisition system.

18. One or more computer-readable media of claim 14, wherein the first call quality metrics includes at least one of:
an average mean opinion score (MOS) associated with the first network,
an average jitter associated with the first network,
an average latency associated with the first network, or
an average packet loss rate associated with the first network.

19. One or more computer-readable media of claim 14, wherein the first cause codes are session initiation protocol (SIP) cause codes and the first call quality metrics includes a reference signal received power (RSRP) metric associated with the first network and a reference signal received quality (RSRQ) metric associated with the first network.

20. One or more computer-readable media of claim 19, wherein the SIP cause codes are received from at least one of a session border controller (SBC) or a telephony application server (TAS).
